(19) United States
(12) Patent Application Publication
(10) Pub. No.: US 2021/0012623 A1
(43) Pub. Date: Jan. 14, 2021

(54) COMBINATION SAFETY PANIC ALARM AND HOLDER FOR CELL PHONE

(71) Applicant: Shmouel GOV-ARI, Riverside, CT (US)

(72) Inventor: Shmouel GOV-ARI, Riverside, CT (US)

(21) Appl. No.: 16/817,750

(22) Filed: Mar. 13, 2020

Related U.S. Application Data
(60) Provisional application No. 62/871,382, filed on Jul. 8, 2019.

(51) Int. Cl. G08B 3/10; A45C 11/00

(52) U.S. Cl. CPC G08B 3/10; A45C 2011/002; A45C 11/00

(57) ABSTRACT

A combined panic alarm and holder for a cell phone includes a frame and a housing, both mounted on the phone, or on a protective case for the phone. A ring is mounted on the frame for movement in a first manual action between a down position and an up position. The ring in the up position is sized to receive a user's finger during use of the phone to prevent the phone from falling. The ring is manually accessible to, and readily manually movable by, the user in a second manual action to actuate an alarm circuit in the housing in an emergency.

### FIELD OF THE DISCLOSURE

The present disclosure generally relates to a panic alarm, and more particularly, to a portable, cell phone-mounted, personal safety alarm that produces an audible, siren-like, sounding alarm that is loud enough to draw attention to a cell phone user in the event of an emergency, and/or that establishes radio communication with a 911 emergency response center and/or with other phones of other designated individuals or responders. Still more particularly, the alarm may be quickly manually actuated by a readily available and accessible phone holder that prevents the cell phone from falling out of the user's hand or grasp during phone use.

### BACKGROUND

Emergency response numbers, such as 911, are utilized to provide individuals with a quick and easy way to contact an emergency response center when an emergency situation arises. It is now possible to carry a cellular telephone that allows an emergency caller to contact an emergency response center from practically anywhere. By providing a standardized method of contacting emergency personnel, these emergency response numbers are effective in reducing the amount of time necessary to respond to an emergency. In an emergency, the amount of time required to respond can often mean the difference between life and death.

A drawback of known cell phone emergency use includes actuating the alarm by performing multiple actions and actuating an alarm button, which may cause confusion in an emergency situation. Because of the stress often associated with emergency situations, an operator of a smartphone may fail to properly perform the correct actions and actuate the correct button and may therefore fail to summon emergency personnel.

Thus, a cell phone personal safety alarm in which the emergency response time is minimized is desired.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is top plan view of a combined panic alarm and a holder mounted in a down or non-actuating storage position on a back wall of a protective case of a mobile cell phone or like portable item in accordance with this disclosure.

FIG. 2 is a top plan view of the combined panic alarm and holder of FIG. 1 with the holder mounted in an up position.

FIG. 3 is a perspective view of the combined panic alarm and holder of FIG. 2.

FIG. 4 is a block diagram depicting electrical components in a housing of the combined panic alarm and holder of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The structural components of the combined panic alarm and holder have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

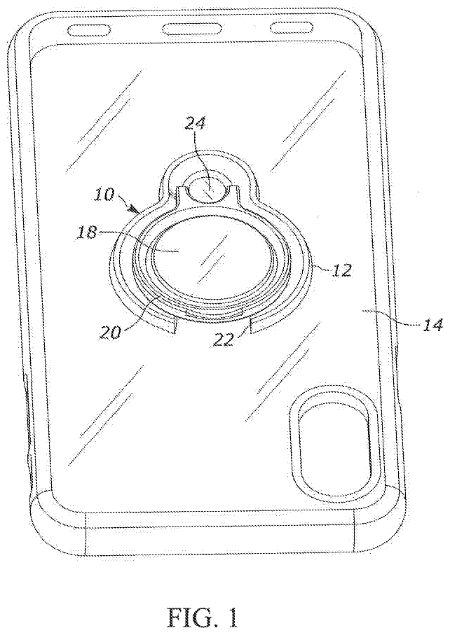

As shown in FIGS. 1-3, a combined panic alarm and holder 10 includes a part-annular, generally U-shaped frame 12 and a circular, button-like housing 18, both adhesively mounted with a removable, pressure-sensitive adhesive at a back or rear planar wall of a protective case 14 of a portable, mobile cell phone or smartphone. The case 14 is optional, because the frame 12 and the housing 18 may also both be adhesively and removably mounted directly to a back or rear planar wall of the cell phone itself. The frame 12 at least partially surrounds the housing 18 in a mutually concentric relationship and is spaced radially outwardly therefrom by an annular gap or recess 16.

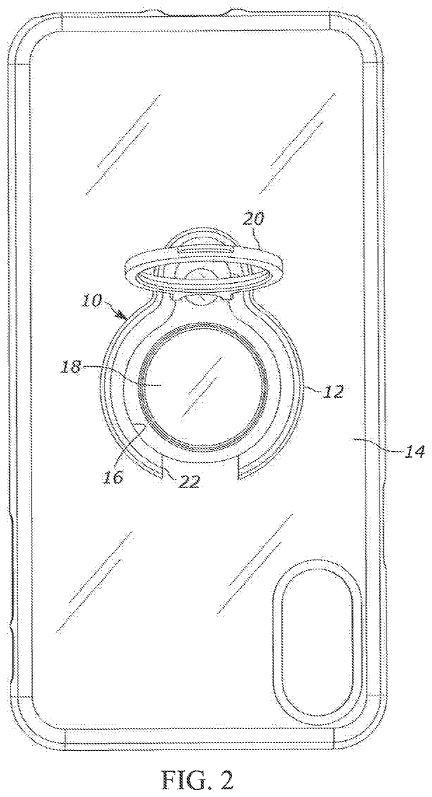

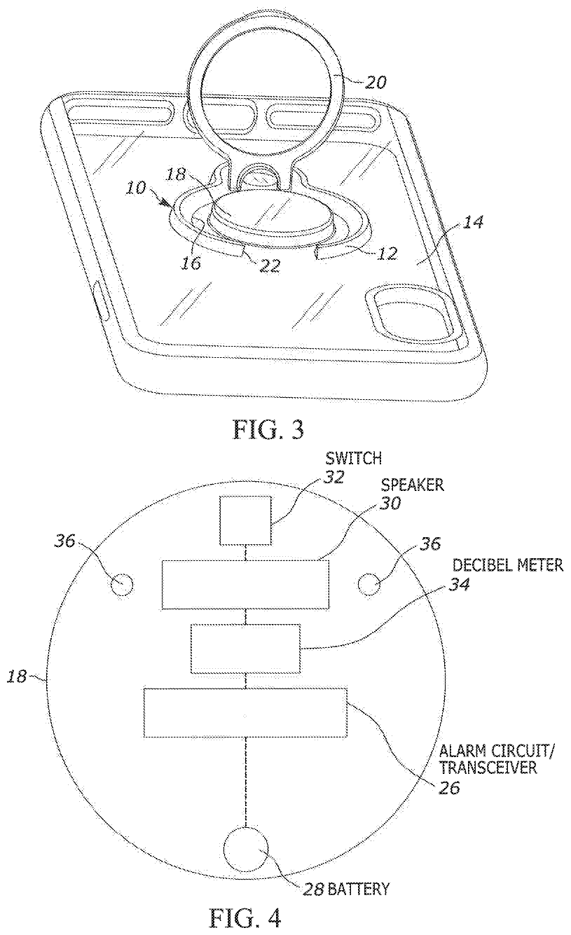

A movable, circular ring 20 is mounted on the frame 12 for pivoting movement in a first manual action along a first direction from a down storage position (FIG. 1) to an up position (FIGS. 2-3). In the down position, the ring 20 is received in the recess 16 and surrounds the circular housing 18. The frame 12 has an open notch 22 through which a user's finger or nail can be inserted to pivot or flip the ring 20 from the down to the up position. The user's finger may be inserted into a central opening of the ring 20 in the up position so that the ring 20 may serve as a holder that prevents the phone from falling out of one's hand or grasp during phone use. In addition, in the up position, as described below, the ring 20 is also mounted on the frame 12 for manual pulling movement, and/or for manual swiveling movement about a pivot 24, in a second manual action that is preferably different from the first action, and along a second direction that is preferably different from the first direction.

As shown in FIG. 4, the circular housing 18 contains an actuatable electronic alarm circuit 26, a battery 28, an energizable speaker 30, an electrical switch 32, and an optional sound pressure level or decibel meter 34, all electrically interconnected in a common circuit. The housing 18 may be configured, in one embodiment, with holes 36 through which the speaker 30 broadcasts a loud alarm sound or siren when the alarm circuit 26 is actuated. In an emergency, the ring 20 in the up position may be manually pulled outwardly in said second action along said second direction generally perpendicular to the back planar wall of the case 14 or phone, and/or may be swiveled or twisted in a circumferential direction, either clockwise or counterclockwise, along another second direction about the pivot 24, to actuate the switch 32, e.g., to change a switching state of the switch 32 from an open to a closed state, to thereby actuate the alarm circuit 26 and, in turn, to energize the speaker 30 to generate the loud alarm sound or siren. Manually pivoting the ring 20 to the down position in a reverse direction opposite to the first direction silences the alarm sound or siren.

In another embodiment, rather than relying solely on the movement of the ring 20, the circular housing 18 may be configured as a button that, when manually pressed, actuates the switch 32 and the alarm circuit 26 and, in turn, energizes the speaker 30 to cause the loud alarm sound or siren to be generated. Manually pressing on the circular housing 18 again silences the alarm sound or siren.

Rather than relying solely on the loud siren to draw attention to the user in the event of an emergency, e.g., a medical emergency or a physical attack, the alarm circuit 26 advantageously includes a Bluetooth transceiver to wirelessly communicate with the mobile phone's on-board microprocessor or controller and, in turn, with the phone's on-board memory. Actuating the alarm circuit 26 by pulling on, or twisting, the ring 20, as described above, generates an electrical alarm signal that automatically wirelessly communicates with the phone's controller and activates an auto-dial call to e-911 (enhanced 911) to notify law enforcement, medical personnel, and/or to any pre-designated individuals or responders whose contact numbers have been entered into and stored in the phone's memory. The auto-dial feature need not be accompanied with a loud siren, because, in some emergency situations, it may be desirable just to generate a silent alarm. In addition, when the loud siren-like alarm generated by the speaker 32 exceeds a predetermined threshold level, e.g., 80 dB or more, the decibel meter 34 detects this excessive sound level and responsively generates an electrical alarm signal that automatically wirelessly communicates with the phone and activates the auto-dial call to e-911 (enhanced 911) to notify emergency responder personnel.

Thus, in accordance with this disclosure, the response time for actuating the safety alarm is minimized, because the user's finger is already normally located in the ring 20 during mobile phone use, and there is a little or negligible time delay in actuating the alarm circuit 26 by the user pulling and/or twisting the ring 20, or pressing on the housing 18, in an emergency.

In the foregoing specification, specific embodiments have been described. However, one of ordinary skill in the art appreciates that various modifications and changes can be made without departing from the scope of the invention as set forth in the claims below. For example, the safety alarm need not only be used with phones, but may be used with other portable or mobile electronic items, such as tablets, headphones, watches, glasses, or computers, as well as non-electronic items, such as handbags, wallets and like portable, hand-supported items. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A combined panic alarm and holder for a portable item supported by a hand of a user during use, comprising:
a frame and a housing both supported by the portable item;
an energizable speaker mounted in the housing for broadcasting an audible alarm when energized;
an actuatable alarm circuit mounted in the housing and operatively connected to the speaker for energizing the speaker when actuated; and
a movable ring mounted on the frame for manual movement in a first manual action between a down storage position and an up position, the ring in the up position having an opening sized to receive a finger of the user during use of the portable item to resist the portable item from falling from the user's hand, the ring being manually accessible to, and readily manually movable in a second manual action by, the user in the up position to actuate the alarm circuit and, in turn, to energize the speaker to broadcast the alarm in an emergency.

2. The combined panic alarm and holder of claim 1, wherein the portable item is a phone, and wherein the frame and the housing are mounted on a back wall of a case that receives the phone.

3. The combined panic alarm and holder of claim 2, and an electrical switch mounted in the housing and operatively connected to the alarm circuit, and wherein the switch changes state to actuate the alarm circuit in response to the second action of the ring.

4. The combined panic alarm and holder of claim 3, wherein the ring is movable in a direction generally perpendicular to the back wall of the case during the second action to actuate the switch.

5. The combined panic alarm and holder of claim 3, wherein the ring is movable in a circumferential direction about an axis generally perpendicular to the back wall of the case during the second action to actuate the switch.

6. The combined panic alarm and holder of claim 1, wherein the ring is pivotable in a first direction from the down storage position to the up position during the first action, and wherein the ring is movable in a second direction different from the first direction during the second action.

7. The combined panic alarm and holder of claim 6, wherein the ring is pivotable in a reverse direction opposite to the first direction from the up position to the down storage position to silence the alarm.

8. The combined panic alarm and holder of claim 1, wherein the housing is circular, and wherein the ring in the down storage position encircles the housing.

9. The combined panic alarm and holder of claim 2, wherein the alarm circuit includes a transceiver for wirelessly communicating with the phone, and for sending an alarm signal to the phone to automatically dial an emergency phone number when the alarm circuit is actuated.

10. The combined panic alarm and holder of claim 9, and a decibel meter mounted in the housing and operatively connected to the alarm circuit, the decibel meter being operative for detecting when the audible alarm exceeds a predetermined threshold, and for responsively actuating the alarm circuit to send the alarm signal to the phone when the threshold is exceeded.

11. The combined panic alarm and holder of claim 1, wherein the frame is partly annular and has an open notch through which the ring in the down position is accessible.

12. A combined panic alarm and holder for a phone supported by a hand of a user during use, comprising:
a partly annular frame and a circular housing both supported by the phone, the frame being mutually concentric with, and radially outwardly spaced from, the housing and bounding an annular recess therewith;
an energizable speaker mounted in the housing for broadcasting an audible alarm when energized;
an actuatable alarm circuit mounted in the housing and operatively connected to the speaker for energizing the speaker when actuated; and
a movable ring mounted on the frame for manual movement in a first manual action between a down storage position and an up position, the ring in the down storage position being situated in the recess and encircling the housing, the ring in the up position having an opening sized to receive a finger of the user during use of the phone to resist the phone from falling from the user's hand, the ring being manually accessible to, and readily manually movable in a second manual action by, the user in the up position to actuate the alarm circuit and, in turn, to energize the speaker to broadcast the alarm in an emergency.

13. The combined panic alarm and holder of claim 12, wherein the ring is movable in a direction generally perpendicular to a back wall of the phone during the second action to actuate the alarm circuit.

14. The combined panic alarm and holder of claim 12, wherein the ring is movable in a circumferential direction about an axis generally perpendicular to a back wall of the phone during the second action to actuate the alarm circuit.

15. The combined panic alarm and holder of claim 12, wherein the ring is pivotable in a first direction from the down storage position to the up position during the first action, and wherein the ring is movable in a second direction different from the first direction during the second action.

16. The combined panic alarm and holder of claim 15, wherein the ring is pivotable in a reverse direction opposite to the first direction from the up position to the down storage position to silence the alarm.

17. The combined panic alarm and holder of claim 12, wherein the alarm circuit includes a transceiver for wirelessly communicating with the phone, and for sending an alarm signal to the phone to automatically dial an emergency phone number when the alarm circuit is actuated.

18. A combined panic alarm and holder for a phone supported by a hand of a user during use, comprising:
a partly annular frame and a circular housing both supported by the phone, the frame being mutually concentric with, and radially outwardly spaced from, the housing and bounding an annular recess therewith;
an energizable speaker mounted in the housing for broadcasting an audible alarm when energized;
an actuatable alarm circuit mounted in the housing and operatively connected to the speaker for energizing the speaker when actuated; and
a movable ring mounted on the frame for manual movement between a down storage position and an up position, the ring in the down storage position being situated in the recess and encircling the housing, the ring in the up position having an opening sized to receive a finger of the user during use of the phone to resist the phone from falling from the user's hand,
the housing being manually accessible to, and readily manually movable in a first manual action by, the user to actuate the alarm circuit and, in turn, to energize the speaker to broadcast the alarm in an emergency, and the housing being manually movable in a second manual action to silence the alarm.
